(19) United States
(12) Patent Application Publication
(10) Pub. No.: US 2011/0165829 A1
(43) Pub. Date: Jul. 7, 2011

(54) AUTOMOTIVE VEHICLE AND METHOD FOR OPERATING CLIMATE SYSTEM OF SAME

(75) Inventors: Bernard D. Nefcy, Novi, MI (US); Derek Hartl, Royal Oak, MI (US); Christopher Adam Ochocinski, Canton, MI (US); William Paul Perkins, Dearborn, MI (US)

(73) Assignee: FORD GLOBAL TECHNOLOGIES, LLC, Dearborn, MI (US)

(21) Appl. No.: 12/712,695

(22) Filed: Feb. 25, 2010

(51) Int. Cl. B60H 1/24

(52) U.S. Cl. 454/75

(57) ABSTRACT

An automotive vehicle may include a container, a battery disposed within the container and configured to provide motive power for the vehicle, and a battery climate system configured to move air from the cabin to the container. The vehicle may also include at least one controller configured to, while the vehicle is in a non-propulsion mode, receive a request to activate the battery climate system and, in response to the request, activate the battery climate system.

### BACKGROUND

Cabin air temperatures of a parked automotive vehicle may be high due to high ambient temperatures and/or heat from direct sun. Upon entering the vehicle, an occupant may experience discomfort from such cabin air temperatures.

### SUMMARY

An automotive vehicle may include a cabin and an energy storage unit, such as a traction battery, disposed within a container. The energy storage unit may be used to provide power to move the vehicle. The vehicle may also include at least one controller and a climate system capable of moving air from the cabin to the container. The at least one controller may receive a request to activate the climate system while the vehicle is in a non-propulsion mode. In response to the request, the at least one controller may activate the battery climate system to, for example, purge air from the cabin and/or cool the energy storage unit.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1 is a block diagram of an embodiment of an automotive vehicle.

FIG. 2 is a block diagram of another embodiment of an automotive vehicle.

FIG. 3 is an example plot of cabin/battery container air temperature versus time.

FIG. 4 is another example plot of cabin/battery container air temperature versus time.

FIG. 5 is yet another example plot of cabin/battery container air temperature versus time.

### DETAILED DESCRIPTION

A vehicle occupant may attempt to cool the vehicle's cabin by opening one or more windows and/or activating the vehicle's air conditioner. Significant time may pass, however, from when the occupant initiates these activities until when the cabin reaches a comfortable temperature.

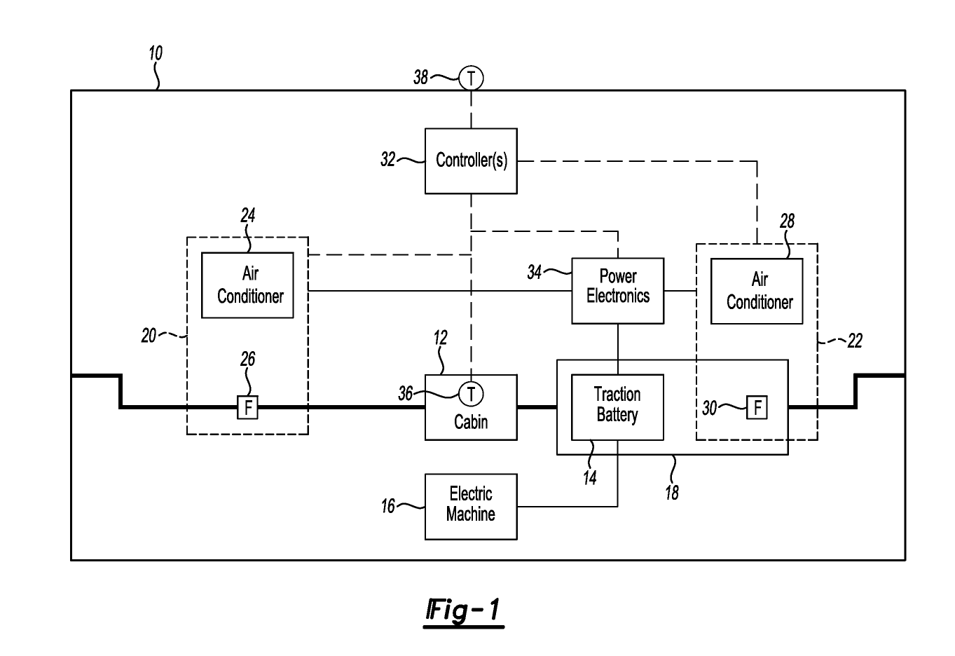

Referring to FIG. 1, an embodiment of an automotive vehicle 10 may include a cabin 12, power storage unit 14 (e.g., traction battery) and electric machine 16. The vehicle 10 of FIG. 1 is a hybrid electric vehicle: power from the traction battery 14 may be used to move the vehicle 10 via the electric machine 16. Power from an engine (not shown) may also be used to move the vehicle 10. Of course, the vehicle 10 may be a battery electric vehicle, a plug-in hybrid electric vehicle, etc. in other embodiments.

The vehicle 10 may be in either of propulsion mode or non-propulsion mode. In propulsion mode, the vehicle 10 may be driven under the power of the engine and/or electric machine 16 (the vehicle 10, however, need not be moving). For example, if the vehicle 10 were to be waiting at a stop light for the light to turn green, the vehicle 10 would be in propulsion mode. In other words, the elements used for propulsion are enabled in propulsion mode.

In non-propulsion mode, the vehicle 10 is not capable of being driven although various vehicle components may nevertheless be powered-up. For example, if the vehicle 10 is in an “off” state, the vehicle 10 would be in non-propulsion mode. In other words, at least one of the elements used for propulsion is disabled or otherwise impeding a driver's request for propulsion so as to prevent propulsion.

The traction battery 14 resides within an enclosure (or container) 18 that houses the traction battery 14. The container 18 may thus provide some level of protection for the traction battery 14 against damage as well as provide a controlled environment, as discussed below, in which the traction battery 14 may operate. In the embodiment of FIG. 1, the container 18 (and thus the traction battery 14) are located behind a rear seat (not shown) of the vehicle 10. The container 18, however, may be positioned within any suitable location within the vehicle 10.

Duct work (or other fluid passageways) connect the cabin 12, the container 18 and outside of the vehicle 10 as indicated by heavy solid line. As discussed in more detail below, air from outside of the vehicle 10 may be pulled through the cabin 12 and the container 18, and then exhausted again to outside of the vehicle 10 to cool the cabin 12 and/or traction battery 14 in advance of an occupant entering the cabin 12. Air from the cabin 12 and/or container 18 may also be periodically purged to keep the temperatures within these areas within some desired range. Other scenarios are also possible and will be explained below.

The vehicle 10, in the embodiment of FIG. 1, also includes a cabin climate system 20 and battery climate system 22. The cabin climate system 20 may include an air conditioner 24 and fan (or other blower) 26. The battery climate system 22 may likewise include an air conditioner 28 and fan (or other blower) 30. The air conditioners 24, 28, in certain embodiments, may be capable of heating, cooling and/or dehumidifying air. Of course, the climate systems 20, 22 may include any/other/fewer suitable components for managing the environment within the cabin 12 and container 18 respectively.

The fan 26 is located within the duct work fluidly connecting outside of the vehicle 10 and the cabin 12. The fan 30 is positioned within the container 18. The fans 26, 30, in other embodiments, may be positioned in any suitable location. For example, the fan 26 may be located in the duct work fluidly connecting the cabin 12 and the container 18. The fan 30 may be located in the duct work fluidly connecting the container 18 and outside of the vehicle 10. Other arrangements are also possible.

As discussed below, cooperative activation of the fans 26, 30 may circulate fresh air through the cabin 12 and container 18 for cooling purposes. Periodic activation of the fan 30 may purge air from the container 18, etc.

The vehicle 10 further includes one or more controllers 32, power electronics 34, cabin temperature sensor 36 and ambient temperature sensor 38. The climate systems 20, 22 are under the influence/control of the controller(s) 32 and may receive power via power electronics 34. Electrical connections are shown in thin solid line. Control channels/communication lines are shown in dashed line.

The controller(s) 32 may, for example, selectively activate the climate systems 20, 22 based on information from the sensors 36, 38 or other information. As an example, a command originating from a key fob and eventually received by the controller(s) 32 may direct the controller(s) 32 to activate the fan 30 to purge air from the cabin 12 and container 18. As another example, the controller(s) 32 may be configured in a known fashion to detect a door open event and, as a result, activate one or both of the fans 26, 30 to purge air from the cabin 12 and container 18. As still yet another example, the controller(s) 32 may periodically activate one or both of the fans 26, 30 if the difference between the temperatures detected by the sensors 36, 38 exceeds some predetermined threshold, e.g., 5° C., etc. Other components of the climate systems 20, 22 may also be activated under similar circumstances.

The controller(s) 32 may discontinue fan/climate system operation after some predetermined time period (e.g., 3 minutes), upon the vehicle 10 entering propulsion mode, or if the temperature within the cabin 12 and/or container 18 achieves some desired value, etc.

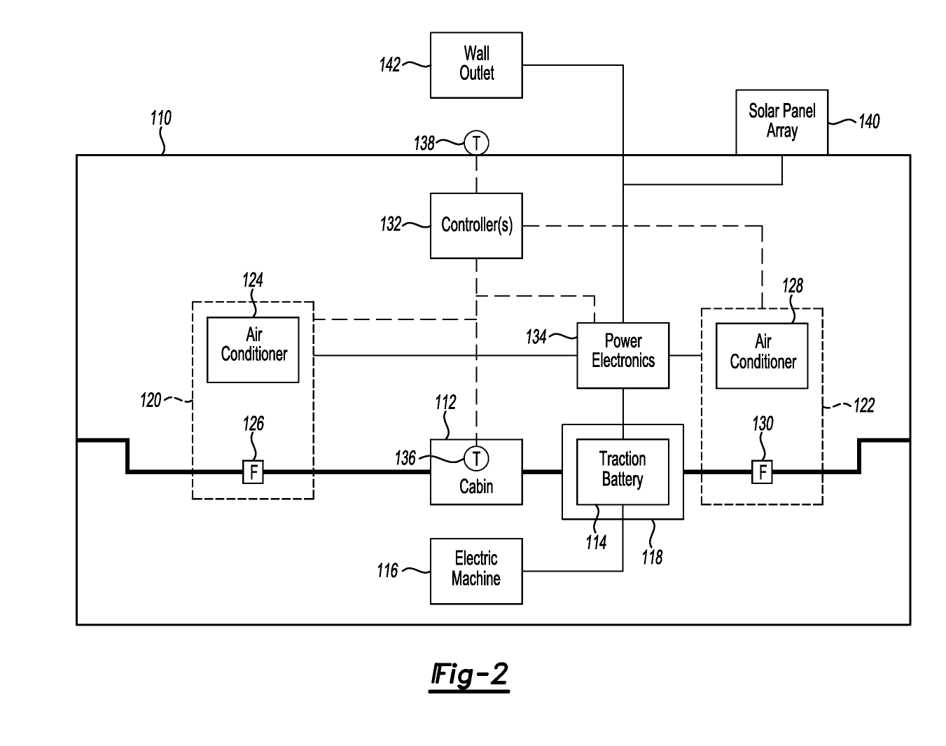

Referring to FIG. 2, numbered elements that differ by 100 relative to FIG. 1 have similar descriptions to the numbered elements of FIG. 1. The vehicle 110 (a plug-in battery electric vehicle in this example), however, includes a solar panel array 140 and/or may receive electrical power from a wall outlet 142 (or other suitable off-board power source). Specifically, the power electronics 134 may receive electrical power from either/both of the solar panel array 140 and wall outlet 142, and use this power to activate either/both of the climate systems 120, 122 under the control of the controller(s) 132.

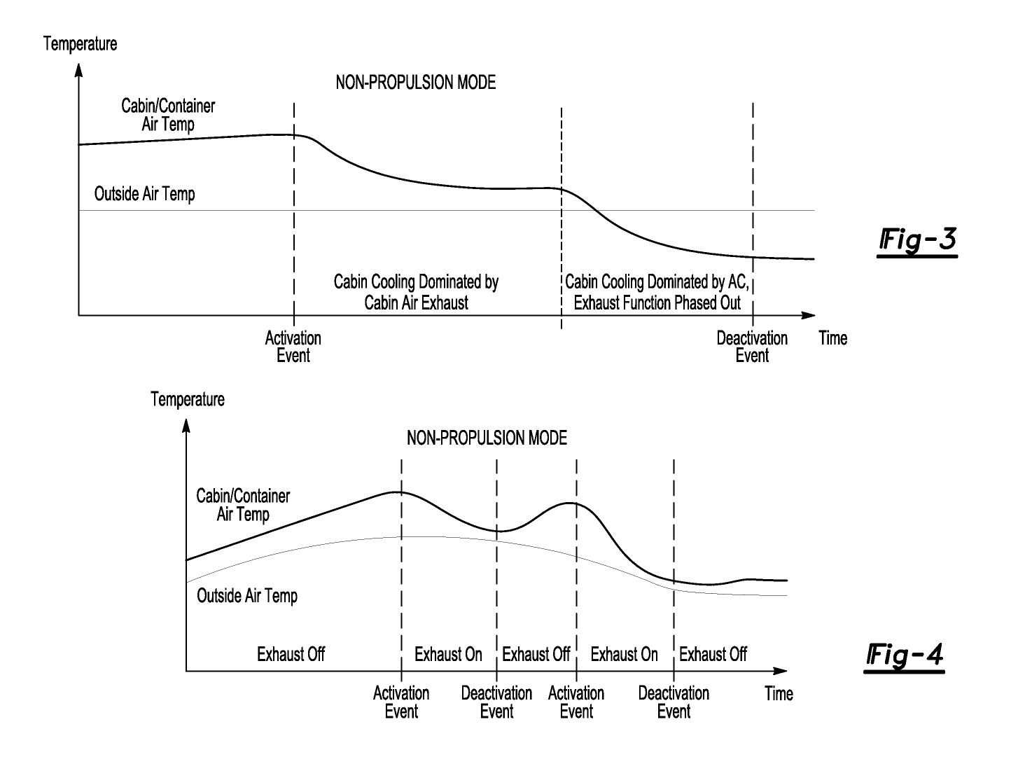

Referring to FIGS. 1 and 3, cabin/container air temperatures may be substantially higher than ambient air temperatures when the vehicle 10 is in the non-propulsion mode. Such high cabin/container air temperatures may cause occupants to experience discomfort upon entering the cabin 12 and/or be less than ideal for operating/charging/discharging the traction battery 14 within the container 18.

The controller(s) 32 may, upon detecting a suitable activation event (such as those discussed above), (i) activate one or both of the fans 26, 30 to circulate fresh air through the cabin 12 and container 18 and/or (ii) activate the air conditioner 24. When one or more of the fans 26, 30 and/or the air conditioner 24 is first activated, cooling in the cabin 12 and container 18 may be dominated by the circulation of fresh air into the cabin 12 and container 18. Once the air conditioner's evaporator is sufficiently chilled, however, cooling in the cabin 12 and container 18 may be dominated by the air conditioner 24. As a result, the operation of one or both of the fans 26, 30 may be discontinued, in some embodiments, once the cabin/container air temperature is near or below the ambient air temperature.

The controller(s) 32 may deactivate the climate systems 20, 22 upon the occurrence of a suitable deactivation event (e.g., the vehicle 10 enters propulsion mode, a predetermined period of time passes, the interior temperature becomes near the ambient temperature, a remote command signal is received, etc.)

Referring to FIGS. 1 and 4, the controllers(s) 32 may wake-up and periodically (e.g., once an hour) determine whether the difference between the cabin/container temperature and the ambient air temperature is greater than some predetermined threshold (e.g., 6° C.). Upon detecting a difference greater than the threshold, the controller(s) 32 may generate a request to activate (and then subsequently activate) one or both of the fans 26, 30 to circulate fresh air through the cabin 12 and container 18. (That is, a first controller may detect that the difference is greater than the threshold and generate the request, and a second controller in communication with the first controller may act on the request to activate one or both of the fans 26, 30.) Once the difference is less than another predetermined threshold (e.g., 2° C.), the controller(s) 32 may discontinue operation of one or both of the fans 26, 30.

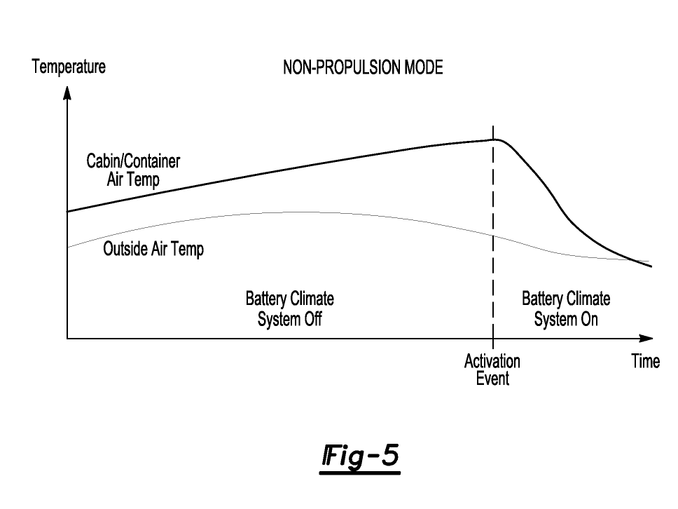

Referring to FIGS. 1 and 5, the controllers(s) 32 may receive a remote command signal to enable the climate system 22. In response, the controller(s) 32 may activate the fan 30 to pull air from the cabin 12 and through the container 18 to purge the air from the cabin 12 and container 18. As the air is pulled from the cabin 12 into the container 18 by the fan 30, fresh ambient air will enter the cabin 12 via the duct work fluidly connecting the outside of the vehicle 10 and the cabin 12. Other scenarios are also possible.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An automotive vehicle comprising:
a cabin;
a cabin climate system configured to move air from outside the vehicle to the cabin;
a container;
an energy storage unit disposed within the container and configured to provide motive power for the vehicle;
an energy storage unit climate system configured to move air from the cabin to the container; and
at least one controller configured to, while the vehicle is in a non-propulsion mode, receive a request to activate the climate systems and, in response to the request, activate the climate systems to move air through the cabin and container.

2. The vehicle of claim 1 wherein the at least one controller is further configured to deactivate at least one of the climate systems if, after a predetermined period of time, the vehicle does not enter a propulsion mode.

3. An automotive vehicle including a cabin comprising:
a container;
a battery disposed within the container and configured to provide motive power for the vehicle;
a battery climate system configured to move air from the cabin to the container; and
at least one controller configured to, while the vehicle is in a non-propulsion mode, receive a request to activate the battery climate system and, in response to the request, activate the battery climate system.

4. The vehicle of claim 3 further comprising a cabin climate system configured to move air from outside the vehicle to the cabin, wherein the at least one controller is further configured to, in response to the request, activate the cabin climate system.

5. The vehicle of claim 4 wherein the at least one controller is further configured to deactivate the cabin climate system if a predetermined event or condition occurs.

6. The vehicle of claim 4 further comprising ducting fluidly connecting the exterior of the vehicle and the cabin, wherein the cabin climate system includes a blower operatively arranged with the at least one controller and disposed within the ducting.

7. The vehicle of claim 4 wherein the cabin climate system includes an air conditioner and wherein the at least one controller is further configured to activate the air conditioner in response to the request.

8. The vehicle of claim 3 further comprising ducting fluidly connecting the cabin, container and vehicle exterior, wherein the battery climate system includes a blower operatively arranged with the at least one controller and disposed within the ducting.

9. The vehicle of claim 3 further comprising power electronics configured to receive power from an off-board electrical power supply, wherein the at least one controller is further configured to activate the battery climate system with power from the off-board electrical power supply via the power electronics.

10. The vehicle of claim 3 further comprising a temperature sensor configured to sense a temperature of the cabin, wherein the at least one controller is further configured to generate the request to activate the battery climate system based on the temperature.

11. The vehicle of claim 3 further comprising (i) at least one solar panel and (ii) power electronics configured to receive electrical power from the at least one solar panel, wherein the at least one controller is further configured to activate the battery climate system with power from the at least one solar panel via the power electronics.

12. The vehicle of claim 3 further comprising an ambient temperature sensor and a cabin temperature sensor each operatively arranged with the at least one controller, wherein the at least one controller is further configured to deactivate the battery climate system if a cabin temperature falls within a predefined range of temperatures relative to an ambient temperature.

13. A method for operating a battery climate system of an automotive vehicle including a cabin, container, and battery disposed within the container and configured to provide motive power for the vehicle, the method comprising:
while the vehicle is in a non-propulsion mode, (i) receiving a request to activate the battery climate system, and (ii) in response to the request, activating the battery climate system to move air from the cabin to the container.

14. The method of claim 13, wherein the vehicle further includes a cabin climate system, further comprising, in response to the request, activating the cabin climate system to move air from outside the vehicle to the cabin.

15. The method of claim 14 further comprising deactivating the battery climate system if a predetermined condition or event occurs.

16. The method of claim 13, wherein the vehicle further includes an air conditioner, further comprising, in response to the request, activating the air conditioner.

17. The method of claim 13 wherein the battery climate system is activated with electrical power from an off-board electrical power supply.

18. The method of claim 13, wherein the vehicle further includes a temperature sensor configured to sense a temperature, further comprising generating the request to activate the battery climate system based on the temperature.

19. The method of claim 13, wherein the vehicle further includes a temperature sensor configured to sense a temperature, further comprising deactivating the battery climate system based on the temperature.
